(19) United States
(12) Patent Application Publication
(10) Pub. No.: US 2016/0249185 A1
(43) Pub. Date: Aug. 25, 2016

(54) ENHANCED WIRELESS MULTICAST DELIVERY

(71) Applicant: QUALCOMM Incorporated, San Diego, CA (US)

(72) Inventors: Ganesh Kondabattini, Hyderabad (IN); Kiran Neelisetty, Hyderabad (IN)

(21) Appl. No.: 14/627,000

(22) Filed: Feb. 20, 2015

(51) Int. Cl. H04W 4/08

(52) U.S. Cl. CPC H04W 4/08; H04L 12/189

(57) ABSTRACT

Methods, systems, and devices are described for wireless communication at an access point (AP). The AP may snoop messages between stations (STAs) and a network. Using information obtained from snooping, the AP may identify which STAs are interested in receiving different multicasts. Accordingly, the AP may generate and maintain a table that maps multicasts to interested STAs. The AP may assign a unique group identity (ID) to STAs interested in a multicast and include the group ID in the frame header of frames for that multicast which are broadcast to the STAs. Thus, STAs interested in receiving the multicast will recognize the group ID in the frame header and decode the entire multicast frame; STAs not interested in receiving the multicast will avoid decoding and processing the entire multicast frame. The AP may also use beamforming to direct the multicast frames to interested STAs and away from uninterested STAs.

### BACKGROUND

1. Field of Disclosure

The following relates generally to wireless communication, for example enhanced wireless multicast delivery.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), may include an access point (AP) that may communicate with one or more stations (STAs) or mobile devices. The AP may be coupled to a network, such as the Internet, and may enable a mobile device to communicate via the network (or communicate with other devices coupled to the access point in a service set, e.g., a basic service set (BSS) or extended service set (ESS)). A wireless device may communicate with a network device bi-directionally. For example, in a WLAN, a STA may communicate with an associated AP via downlink (DL) and uplink (UL). From the STA's perspective, the DL (or forward link) may refer to the communication link from the AP to the station, and the UL (or reverse link) may refer to the communication link from the station to the AP.

In some wireless networks, the same data may be intended for or useful to multiple STAs served by an AP. In such instances, the AP may transmit the data as multicast. However, the multicast may be sent to all STAs served by the AP, regardless of whether all of the STAs served by the AP are interested in the data. Thus, STAs which are not assigned the multicast data may expend power and processing resources to receive and process the unwanted multicast transmission, which may result in system inefficiencies, reduced battery life, and poor user experience.

### SUMMARY

Systems, methods, and apparatuses for enhanced wireless multicast delivery are described. In a wireless communication system, an access point (AP) may snoop subscriber messages between stations (STAs) and a network. Using information obtained from the snooping, the AP may identify which STAs are interested in receiving different multicasts. Using this information, the AP may generate and maintain a table at the bridge level mapping multicasts to interested STAs. The AP may assign a unique group identity (ID) to STAs interested in a multicast and include the group ID in the frame header of frames for that multicast which are broadcast to the STAs. In this way, STAs interested in receiving the multicast will recognize the group ID in the frame header and decode the entire multicast frame, and STAs not interested in receiving the multicast will avoid decoding and processing the entire multicast frame. In some cases, the AP may also use beamforming to direct the multicast frames to interested STAs and away from uninterested STAs.

A method of communication at a wireless device is described. The method may include determining, via internet group management protocol (IGMP) snooping, that a station is associated with a multicast, assigning a group ID to the station based at least in part on the determination, and transmitting a frame comprising data for the multicast to the station, the frame comprising a header that conveys the assigned group ID.

An apparatus for communication at a wireless device is described. The apparatus may include an IGMP snooper for determining, via internet group management protocol (IGMP) snooping, that a station is associated with a multicast, a multicast assignment coordinator for assigning a group ID to the station based at least in part on the determination, and a transmitter for transmitting a frame comprising data for the multicast to the station, the frame comprising a header that conveys the assigned group ID.

A further apparatus for communication at a wireless device is described. The apparatus may include means for determining, via internet group management protocol (IGMP) snooping, that a station is associated with a multicast, means for assigning a group ID to the station based at least in part on the determination, and means for transmitting a frame comprising data for the multicast to the station, the frame comprising a header that conveys the assigned group ID.

A non-transitory computer-readable medium storing code for communication at a wireless device is described. The code may include instructions executable to determine, via internet group management protocol (IGMP) snooping, that a station is associated with a multicast, assign a group ID to the station based at least in part on the determination, and transmit a frame comprising data for the multicast to the station, the frame comprising a header that conveys the assigned group ID.

Assigning the group ID to the station may further comprise transmitting the group ID to the station prior to transmitting the frame comprising the data for the multicast. Transmitting the frame may further comprise using beamforming to steer transmission of the frame to the station.

Transmitting the frame may further comprise identifying the station as one of a plurality of stations associated with the group ID and using beamforming to steer transmission of the frame to the plurality of stations.

The method, apparatuses, or non-transitory computer-readable medium described above may further include processes, features, means, or instructions for avoiding delivering the frame to a set of stations unassociated with the group ID. The method, apparatuses, or non-transitory computer-readable medium described above may further include processes, features, means, or instructions for determining the group ID based at least in part on a multicast address of the multicast.

The method, apparatuses, or non-transitory computer-readable medium described above may further include processes, features, means, or instructions for maintaining a bridge-level table, the bridge-level table identifying the association between the station and the multicast. The method, apparatuses, or non-transitory computer-readable medium described above may further include processes, features, means, or instructions for determining the group ID based at least in part on the bridge-level table.

The method, apparatuses, or non-transitory computer-readable medium described above may further include processes, features, means, or instructions for updating the bridge-level table based at least in part on the IGMP snooping.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) for enhanced wireless multicast delivery configured in accordance with various aspects of the present disclosure

FIG. 2 illustrates an example of a wireless communications system for enhanced wireless multicast delivery in accordance with various aspects of the present disclosure;

FIG. 3A illustrates an example of a multicast frame for enhanced wireless multicast delivery in accordance with various aspects of the present disclosure;

FIG. 3B illustrates an example of a signal field for enhanced wireless multicast delivery in accordance with various aspects of the present disclosure;

FIG. 4A illustrates an example of a beamforming scheme for enhanced wireless multicast delivery in a wireless communications system in accordance with various aspects of the present disclosure;

FIG. 4B illustrates an example of a beamforming scheme for enhanced wireless multicast delivery in a wireless communications system in accordance with various aspects of the present disclosure;

FIG. 5 illustrates an example of a process flow for enhanced wireless multicast delivery in accordance with various aspects of the present disclosure;

FIG. 6 shows a block diagram of an access point (AP) configured for enhanced wireless multicast delivery in accordance with various aspects of the present disclosure;

FIG. 7 shows a block diagram of an AP configured for enhanced wireless multicast delivery in accordance with various aspects of the present disclosure;

FIG. 8A shows a block diagram of a system including a device configured for enhanced wireless multicast delivery in accordance with various aspects of the present disclosure;

FIG. 8B shows a block diagram of a system including a device configured for enhanced wireless multicast delivery in accordance with various aspects of the present disclosure;

FIG. 9 a flowchart illustrating a method for enhanced wireless multicast delivery in accordance with various aspects of the present disclosure;

FIG. 10 shows a flowchart illustrating a method for enhanced wireless multicast delivery in accordance with various aspects of the present disclosure;

FIG. 11 shows a flowchart illustrating a method for enhanced wireless multicast delivery in accordance with various aspects of the present disclosure;

FIG. 12 shows a flowchart illustrating a method for enhanced wireless multicast delivery in accordance with various aspects of the present disclosure;

FIG. 13 shows a flowchart illustrating a method for enhanced wireless multicast delivery in accordance with various aspects of the present disclosure;

### DETAILED DESCRIPTION

The described features generally relate to improved systems, methods, or apparatuses for enhanced wireless multicast delivery. According to the present disclosure, an access point (AP) may implement internet group management protocol (IGMP) snooping at the Layer 2 (L2) level. That is, the AP may use wireless IGMP snooping to listen to IGMP message exchanges (e.g., Membership Report, Leave Report, Query Report) between a network and client stations (STAs) served by the AP. The AP may use subscriber information obtained from the IGMP snooping to associate individual STAs with multicasts to which the STAs have subscribed or expressed interest.

Multicasts serviced by the AP may be associated with individual group IDs. When the AP detects that a STA has subscribed to or is otherwise associated with a multicast, the AP may assign an individual group ID to that STA. The AP may include the assigned group ID in the frame header of multicast frames for the associated multicast such that STAs interested in receiving the multicast will recognize the group ID in the frame header and decode the multicast frame. STAs not interested in receiving the multicast (i.e. STAs not assigned the group ID) may avoid decoding and processing the multicast frame, thereby saving resources.

The AP may track associations between STA and multicasts using a bridge-level table. The bridge-level table may map multicast group addresses to STA addresses. The bridge-level table may be maintained and updated based on the IGMP snooping. The AP may also use beamforming to deliver multicast frames to a single client, steering the multicast frames to interested STAs and away from uninterested STAs.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

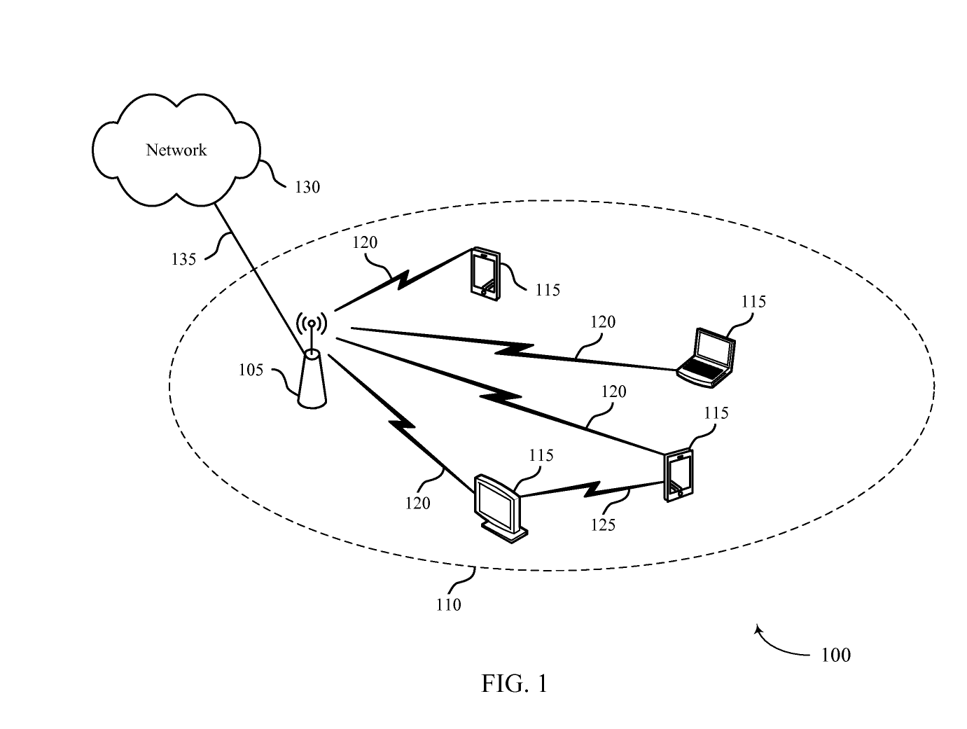

FIG. 1 illustrates a wireless local area network (WLAN) 100 (also known as a Wi-Fi network) configured in accordance with various aspects of the present disclosure. The WLAN 100 may include an access point (AP) 105 and multiple associated client station (STAs) 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 may communicate with the STAs 115 within coverage area 110 via communication links 120. In some cases, communication links 120 may be implemented using beamforming. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (DS) (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110 or wirelessly connected to the same AP 105 or BSS. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within WLAN 100.

An AP 105 may communicate with a network 130, such as the Internet, via a wired or wireless communication link 135. The AP 105 may receive data from the network 130 which is intended for a single STA 115, or multiple STAs 115, within coverage area 110. Accordingly, the AP 105 may transmit data via unicast (e.g., one-to-one) or multicast (e.g., one-to-many) transmissions to STAs 115. The STAs 115 may select which multicasts are of interest by subscribing to multicast addresses using internet group management protocol (IGMP). For example, the network 130 may send membership queries to a STA 115 to determine the multicast addresses in which the STA 115 is interested. Accordingly, the STA 115 may indicate interest in multicast addresses by sending membership reports and leave group messages to the network 130. The AP 105 may serve as the gateway between a STA 115 and the network 130, and as such may be privy to the IGMP exchanges. Thus, the AP 105 may snoop IGMP message exchanges between a STA 115 and network 130 and determine relationships between multicast addresses and the STA 115. For example, the AP 105 may listen for IGMP messages from the STAs 115 and update the table accordingly. When the AP 105 detects a membership report for a multicast address from a STA 115, the AP 105 may update the table to indicate that the STA 115 is registered to receive the multicast frames from that particular multicast address. When the AP 105 detects a leave group report for the STA 115, the AP 105 may clear the table entry for that multicast address and STA 115.

To summarize, an AP 105 may use IGMP snooping to listen to IGMP message exchanges between a network 130 and STAs 115. The AP 105 may use subscriber information obtained from the IGMP snooping to associate STAs 115 with multicast addresses. Based on the IGMP snooping, the AP 105 may establish and maintain a bridge-level table which maps multicast group addresses to STAs 115. The AP 105 may assign group identifiers (IDs) to STAs 115 based on the IGMP snooping. For example, the AP 105 may assign a unique group ID to a STA 115 which is registered to receive multicasts with a particular address M. The AP 105 may notify the STA 115 of the assigned group ID, and include the group ID in future multicasts with address M. Thus, the STA 115 may monitor multicasts for the group ID, and determine the relevance of the multicast based on the presence or absence of the group ID. If the group ID for the STA 115 is present in the multicast (e.g., in a frame header), the STA 115 may process the entire multicast. However, if the group ID for the STA 115 is not present in the multicast, the STA 115 may refrain from processing the multicast and enter a low power mode.

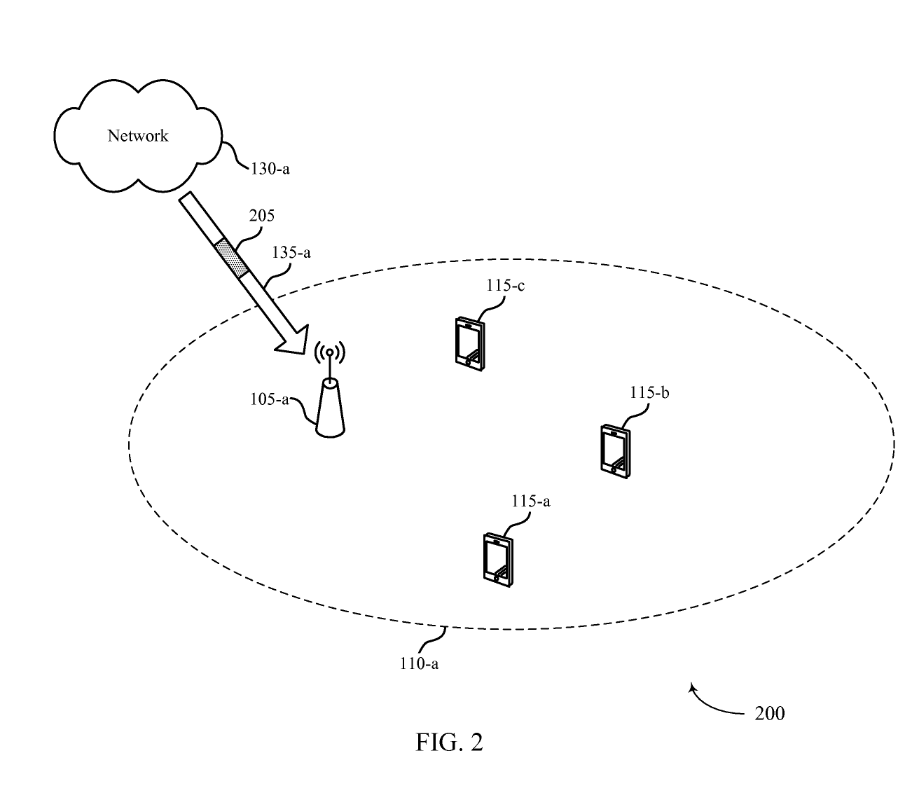

FIG. 2 illustrates an example of a wireless communications system 200 for enhanced wireless multicast delivery in accordance with various aspects of the present disclosure. The wireless communications system 200 may include STAs 115-a, 115-b, and 115-c, which may be examples of one or more STAs 115 described with reference to FIG. 1. The wireless communications system 200 may also include an AP 105-a, which may be an example of an AP 105 described above with reference to FIG. 1. AP 105-a may communicate with STAs 115 within coverage area 110 as described in FIG. 1. AP 105-a may communicate data intended for specific STAs 115 in point-to-point unicast transmissions. AP 105-a may also communicate data to STAs 115 via multicast, which may involve a one-to-many transmission scheme.

The wireless communications system 200 may also include a network 130-a, which may be an example of the network 130 described with reference to FIG. 1. The network 130-a may communicate with AP 105-a via a wired or wireless communication link 135-a, which may be an example of the wired or wireless communication link 135 of FIG. 1. The STAs 115 may communicate with network 130-a indirectly via AP 105-a. Thus, AP 105-a may listen to communications between the STAs 115 and the network 130-a. For example, the AP 105-a may snoop and interpret IGMP message exchanges (e.g., Membership Report messages, Leave Report messages, and Query Report Messages) between the STAs 115 and the network 130-a. Using information gained from the IGMP snooping, the AP 105-a may generate an association table at the bridge-level that maps relationships between multicast addresses and the STAs 115.

As the STAs 115 subscribe and unsubscribe to multicast addresses using IGMP, AP 105-a may dynamically update the bridge-level association table. For example, STA 115-c may indicate, via IGMP messages, that it is interested in receiving multicasts with address M, while STA 115-a and STA 115-b may indicate that they are not interested in multicasts with address M. The STAs 115 may indicate disinterest by not subscribing to an address, or, in the event the STAs 115 are already subscribed, by unsubscribing. Accordingly, AP 105-a may update the bridge-level table to reflect the subscription changes. In other examples, AP 105-a may ascertain the interest of a STA 115 via other means (e.g., through a secondary party or the STA 115). Regardless of how AP 105-a gauges the interest of the STAs 115, AP 105-a may group the STAs 115 according to common interests.

Once the STAs 115 have been grouped, the AP 105-a may assign group IDs to STAs 115. The assignment of the group IDs may be based on the subscription information in the bridge-level table, such as a multicast addresses. Using the example from above, AP 105-a may assign a unique group ID to STA 115-c which is registered to receive multicasts with address M. AP 105-a may transmit the assigned group ID to STA 115-c, which may reference the group ID in order to determine multicast association. Thus, a STA 115 may determine which group ID is assigned based on a group ID indication from AP 105-a. The AP 105-a may indicate group IDs to the STAs 115 based on a change in subscription, or on some external factor (e.g., according to a timer or external request).

In addition to relaying IGMP messages and transmitting group IDs, AP 105-a may facilitate multicast communications from the network 130-a to the STAs 115. For example, the network 130-a may convey multicast data 205 to AP 105-a with data intended for STAs 115 within and outside of coverage area 110-a. However, within coverage area 110-a, STA 115-c alone may be interested in the multicast data 205. By referencing the bridge-level table, the AP 105-a may determine the respective interest of each STA 115 regarding multicast data 205. AP 105-a may also determine which group ID is associated with the multicast, and attach it to a frame header of a multicast prior to transmission. Accordingly, the STAs 115 may receive the multicast transmission which conveys the frame header with the group ID.

The presence of the group ID in the frame header may indicate to the STAs 115 the relevance of the multicast data. For example, if STA 115-a and STA 115-b detect the multicast frames, STA 115-a and STA 115-b may ignore the frames based on the group ID in the header because the group ID is not assigned to STA 115-a and STA 115-b. On the other hand, STA 115-c may know to decode the multicast frame based on its recognition of the assigned group ID. If a STA 115 is associated with the group ID conveyed by the multicast frame header, the STA 115 may determine that the multicast is of interest and process the rest of the frame. If the STA 115 is unassociated with the conveyed group ID, the STA 115 may refrain from processing the rest of the frame.

To summarize one possible scenario, AP 105-a may assign group IDs to STAs 115 which are associated with the same multicast addresses. AP 105-a may determine which STAs 115 are interested in a multicast by snooping IGMP subscriber messages. Based on the IGMP snooping, AP 105-a may establish and maintain a bridge-level table which maps multicast group addresses to STAs 115. AP 105-a may indicate the assigned group IDs to the STAs 115, and the STAs 115 may monitor future multicasts for the group IDs. AP 105-a may convey a group ID in a multicast frame header, which the STAs 115 may detect to determine if the frame should be processed. If a STA 115 is assigned the frame header group ID, the STA 115 may process the multicast frame. If the STA 115 is not assigned the frame header group ID, the STA 115 may refrain from processing the multicast frame.

In some cases, AP 105-a may use beamforming to direct the multicast frame in the direction of interested STA 115-c and away from uninterested STAs 115-a and 115-b. While AP 105-a may not always steer the multicast frames away from all uninterested STAs 115, the combination of beamforming with the inclusion of the group ID in the header of multicast frames may substantially reduce the time and power expended by uninterested STAs 115 to receive or process unwanted multicast frames.

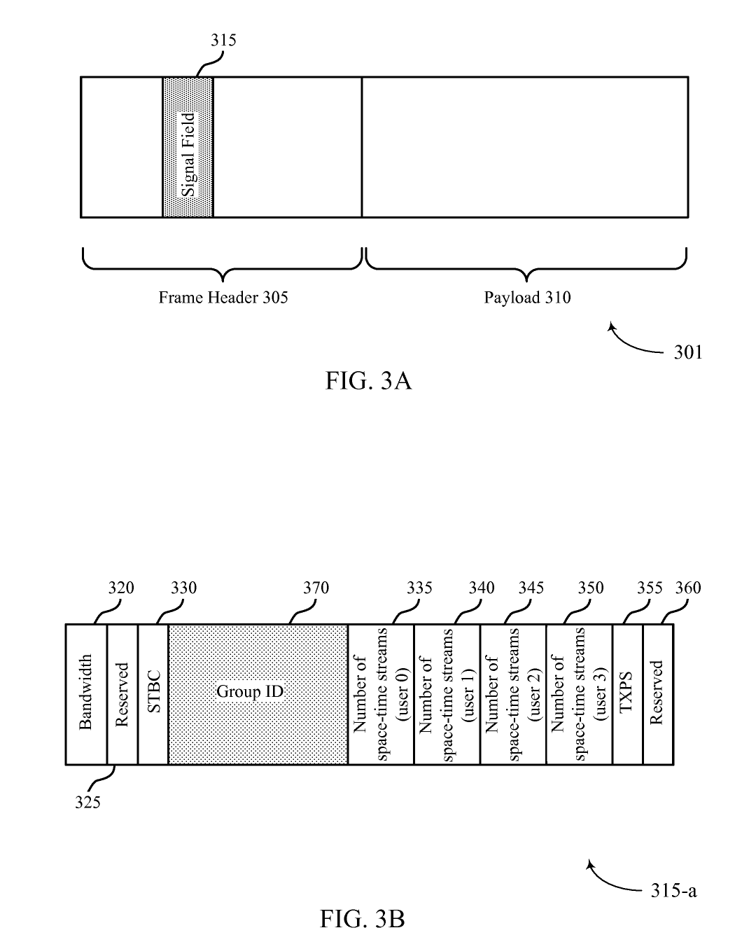

FIG. 3A illustrates an example of a multicast frame 301 for enhanced wireless multicast delivery in accordance with various aspects of the present disclosure. The multicast frame 301 may be an example of a frame transmitted from an AP 105 to a STA 115, as described with reference to FIGS. 1-2.

The multicast frame 301 may include a frame header 305 and a payload 310. The frame header 305 may be a physical layer header, such as physical layer convergence protocol (PLCP) header. The frame header 305 may include a signal field 315 which facilitates decoding of the payload 310 by describing the parameters used for transmission (e.g., channel bandwidth, encoding information, etc.). The signal field 315 may be partitioned into two separate parts—a very-high throughput signal A (VHT-SIG-A), which may be associated with all STAs 115, and a very-high throughput signal B (VHT-SIG-B), which may be specific to individual STAs 115. In some configurations, the signal field 315 may be used to convey a unique group ID assigned to a STA 115 according to a relationship between the STA 115 and a multicast, as described with respect to FIGS. 1-2. The payload 310 may include multicast data intended for one or more STAs 115 served by one or more APs 105. In some cases, the payload 310 may be encoded with space-time block coding (STBC), which may increase robustness. Thus, an AP 105 may transmit the multicast frame 301 as part of a multicast transmission to a STA 115, as described generally in FIGS. 1-2.

FIG. 3B illustrates an example of a signal field 315-a for enhanced wireless multicast delivery in accordance with various aspects of the present disclosure. The signal field 315-a may be an example of at least a portion of the signal field 315 described with reference to FIG. 3A. For example, the signal field 315-a may be a VHT-SIG-A. The signal field 315-a may include control information relevant to STAs 115 served by an AP 105. The signal field 315-a may include a group ID 370, which may be an example of a group ID described in FIGS. 1-3A. In some cases, the group ID 370 may be unique to a single STA 115; in other examples, the group ID 370 may be unique to a number of STAs 115. Group ID 370 may be assigned according to a single multicast a STA 115 is registered to receive, or according to multiple multicasts a STA 115 is registered to receive. For example, a STA 115 may be registered to receive five different multicasts. In some examples, instead of assigning a group ID 370 for each multicast, an AP 105 may assign a single group ID 370 corresponding to the five multicasts.

Thus, an AP 105 may indicate the relevance of a multicast frame to a STA 115 by conveying a group ID 370 in a signal field 315-a of multicast frame header. The group ID 370 may associate a STA 115 with a multicast address, and may be determined via IGMP snooping (e.g., by referencing a bridge-level table based on IGMP snooping). In some cases the AP 105 may notify a STA 115 of the assigned group ID 370 by transmitting the group ID 370 to the STA 115 prior to the multicast. Accordingly, the STA 115 may determine how to process a multicast frame based on the assigned group ID 370. In some cases, an AP 105 may convey a multicast with group ID 370 to a STA 115 by steering the multicast in the direction of the STA 115. For example, the AP 105 may use beamforming to target interested STAs 115 for the reception of a multicast.

The signal field 315-a may include a bandwidth field 320 to convey the bandwidth of the channel used to for the multicast transmission and reserved fields 325, 360. If the payload corresponding to the signal field 315-a is encoded with STBC, the AP 105 may indicate the encoding via an STBC field 330. Space-time stream fields 335, 340, 345, and 350 may be used to indicate the number of space-time streams (e.g., multiple-input multiple-output (MIMO) streams) used for individual recipient STAs (i.e., users 0-3). For example, one space-time stream field 335 may indicate to a first STA 115 (e.g., user 0) the number of space-time streams used to convey a multicast to that particular STA 115. A transmit power save forbidden (TXPS) field 355 may indicate whether the AP 105 allows STAs 115 to power off radios when the STAs 115 have the opportunity to transmit.

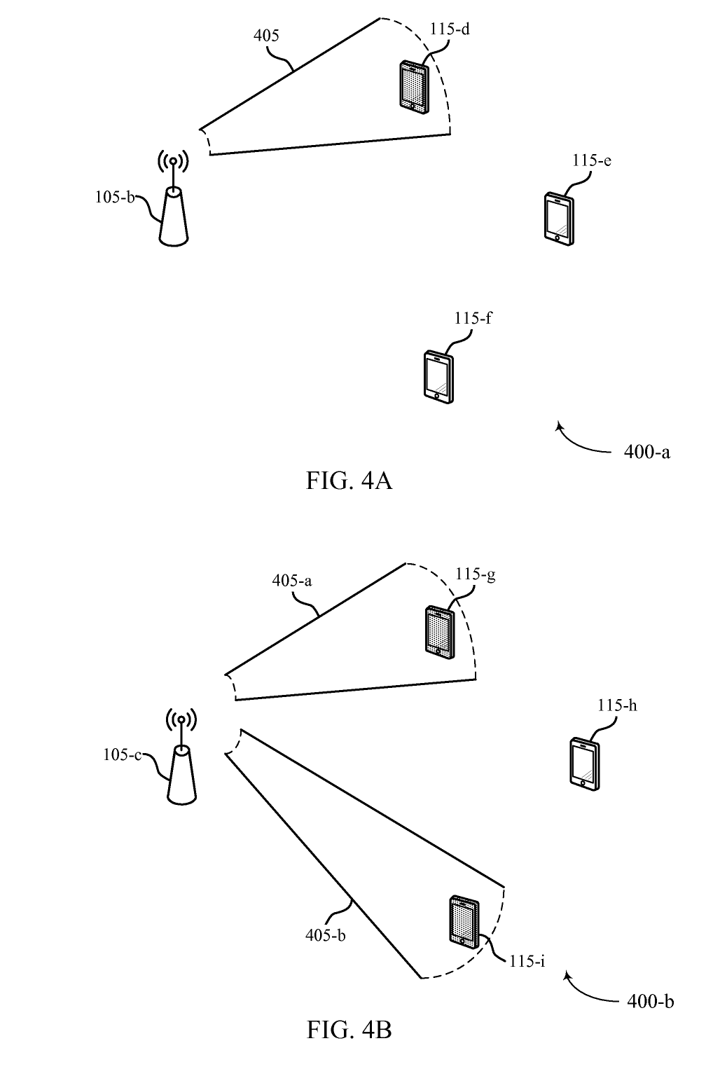

FIG. 4A illustrates an example of a beamforming scheme for enhanced wireless multicast delivery in a wireless communications system 400-a in accordance with various aspects of the present disclosure. The wireless communications system 400-a may include an AP 105-b, which may be an example of an AP 105 described above with reference to FIGS. 1-2. The wireless communications system 400-a may also include STA 115-d, STA 115-e, and STA 115-f, which may be examples of a STA 115 described above with reference to FIGS. 1-2. The STAs 115 may exchange IGMP messages with a network (not shown) which AP 105-b may intercept and decode to associate individual STAs 115 with individual multicasts. AP 105-b may assign group IDs to STAs 115 based on multicast associations and include the group IDs in multicast frames transmitted over the wireless medium.

Some APs 105 may use an array of antennas to direct the energy of a signal in a chosen angular direction. This technique is known as beamforming, and may be implemented by adjusting signal weights and antenna orientations such that interference is produced according to a desired pattern. Thus, an AP 105 may steer a signal, via high energy signal beams, in a particular angular direction.

In the present example, AP 105-b may use beamforming to steer multicast transmissions to interested STAs 115 and avoid transmitting multicasts to disinterested STAs 115. For example, STA 115-d may be subscribed to receive a particular multicast, while STA 115-e and STA 115-f may not be interested in receiving the multicast. In this instance, AP 105-b may use beamforming to steer frames for the multicast in the direction of STA 115-d and away from STA 115-e and STA 115-f. For example, multicast frames may be transmitted in beam 405, which may encompass intended target STA 115-d while avoiding unintended targets STA 115-e and STA 115-f. AP 105-b may determine the direction of the beam 405 based on the location of the interested STA 115-d, the location of the uninterested STAs 115-e, 115-f, or a combination thereof. In some cases, the STAs 115 may be grouped such that beam 405 containing the multicast frames unavoidably encompasses uninterested STAs 115. In such scenarios, AP 105-b may select a direction for the beam 405 which reduces the encompassment of uninterested STAs 115. In any event, a STA 115 which detects a multicast frame via the beam 405 may identify whether the multicast frame is relevant to that particular STA 115 prior to decoding the entire multicast frame (e.g., the STA 115 may determine whether a header of the multicast frame carries a group ID assigned to that STA 115).

FIG. 4B illustrates an example of a beamforming scheme for enhanced wireless multicast delivery in a wireless communications system 400-b in accordance with various aspects of the present disclosure. The wireless communications system 400-b may include AP 105-b, which may be an example of an AP 105 described above with reference to FIGS. 1-2 and 4A. The wireless communications system 400-b may also include STAs 115-g, STA 115-h, and STA 115-i, which may be examples of a STA 115 described above with reference to FIGS. 1-2 and 4A.

In some cases, more than one STA 115 served by AP 105-c may be interested in a multicast. In the present example, STA 115-g and STA 115-i may be registered to receive a particular multicast while STA 115-h may be uninterested in the multicast. AP 105-c may determine use IGMP snooping to associate STA 115-g and STA 115-i with the multicast as described above. This association may be recorded in a bridge-level table. AP 105-c may assume that STA 115-h is not interested in the multicast. Accordingly, AP 105-c may assign the same group ID to STA 115-g and STA 115-i. AP 105-c may adjust transmission of multicast frames according to the known association of STA 115-g and STA 115-i with the multicast. For instance, AP 105-c may use beamforming to direct the multicast frames in the respective directions of STA 115-g and STA 115-i. As shown in FIG. 4B, the AP 105-c may direct the multicast signal in the direction of STA 115-g and STA 115-i via beams 405-a and 405-b. Thus, AP 105-c may refrain from or avoid delivering the multicast frames to STA 115-h. In the present example, each beam 405 is shown as being directed to a single STA 115 for the sake of simplicity, but it should be understood that interested STAs 115 may be grouped such that a single beam conveys multicast frames to more than one interested STA 115.

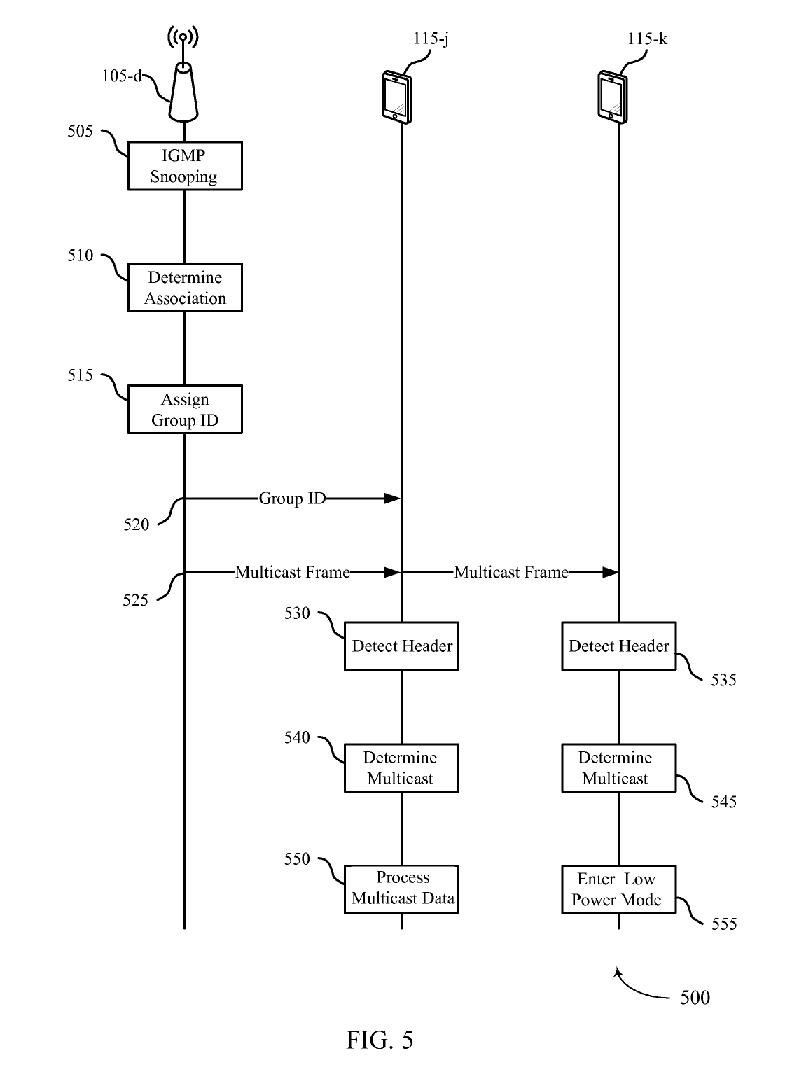

FIG. 5 illustrates an example of a process flow 500 for enhanced wireless multicast delivery in a wireless communications system. The wireless communications system may include AP 105-d, which may be an example of an AP 105 described above with reference to FIGS. 1, 2, 4A and 4B. The wireless communications system may also include STA 115-j and STA 115-k, which may be examples of a STA 115 described above with reference to FIGS. 1, 2, 4A and 4B.

At 505, AP 105-d may perform IGMP snooping on IGMP message exchanges between the STAs 115 and a network. Through the IGMP snooping, the AP 105-d may intercept and decode multicast registration and deregistration messages to maintain and update a bridge-level table that identifies the associations between the STAs 115 and multicasts.

At 510, AP 105-d may determine, via the IGMP snooping, that STA 115-j is associated with a multicast. This determination may be based at least in part on an intercepted multicast registration message sent from STA 115-j to a server associated with generating the multicast content. The AP 105-d may also determine that STA 115-k is unassociated with the multicast based at least in part on an absence of a multicast registration message from STA 115-k or an intercepted multicast deregistration message from STA 115-k.

At 515, AP 105-d may assign a group identification (ID) to STA 115-j based on the determined multicast association. AP 105-d may assign the group ID based on the bridge-level table or on a multicast address of the multicast.

At 520, AP 105-d may transmit the assigned group ID to STA 115-j. In other words, AP 105-d may inform STA 115-j of the assigned group ID prior to transmitting a multicast frame for the multicast associated with STA 115-j. STA 115-j may store the group ID received from AP 105-d. In some cases, STA 115-j may have more than one group ID, each of which may associate STA 115-j with a separate multicast. Additionally or alternatively, a single group ID may associate a STA 115 with multiple multicasts.

At 525, AP 105-d may transmit a multicast frame for the multicast to STA 115-j and STA 115-k. The multicast frame may include a header that conveys the group ID assigned to STA 115-j. In one example, AP 105-d may attempt to avoid transmitting the frame to STA 115-k, which is unassociated with the group ID. For instance, AP 105-d may use beamforming to steer transmission of the frame to STA 115-j.

At 530 and 535, STA 115-j and STA 115-k may detect the frame header of the multicast, respectively. At 540, STA 115-j may determine that the frame header includes a group ID. Furthermore, STA 115-j may determine that the group ID conveyed by the header corresponds to the assigned group ID from 520. At 545, STA 115-k may determine that the frame header conveys a group ID which is unassociated with STA 115-k. Accordingly, STA 115-j and STA 115-k may determine the extent to which the frame is processed based at least in part on the conveyed group ID. Thus, at 550 and 555, STA 115-j may process the entire multicast frame, and STA 115-k may discontinue processing of the multicast frame, respectively.

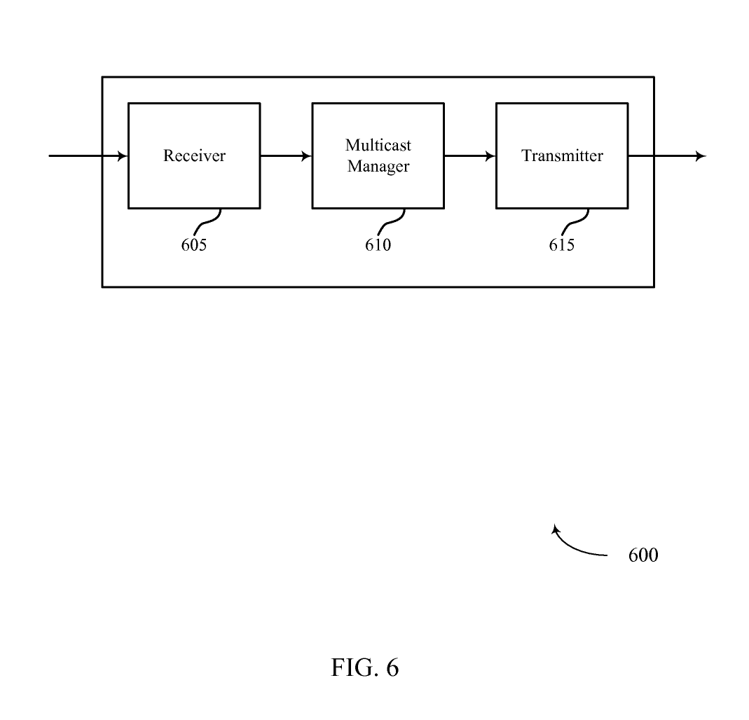

FIG. 6 shows a block diagram of a wireless device 600 configured for enhanced wireless multicast delivery in accordance with various aspects of the present disclosure. The wireless device 600 may be an example of aspects of an AP 105 described with reference to FIGS. 1-5. The wireless device 600 may include a receiver 605, a multicast manager 610, and a transmitter 615. The wireless device 600 may also include a processor. Each of these components may be in communication with each other.

The components of wireless device 600 may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 605 may receive information such as packets, user data, or control information associated with various information channels (e.g., control channels, data channels, and information related to enhanced wireless multicast delivery, etc.). Information may be passed on to the multicast manager 610, and to other components of wireless device 600.

The multicast manager 610 may determine, via internet group management protocol (IGMP) snooping, that a station is associated with a multicast, assign a group ID to the station based at least in part on the determination, and transmit a frame comprising data for the multicast to the station. The frame may include a header that conveys the assigned group ID.

The transmitter 615 may transmit signals received from other components of wireless device 600. In some embodiments, the transmitter 615 may be collocated with the receiver 605 in a transceiver. The transmitter 615 may include a single antenna, or it may include a plurality of antennas. In some examples, the transmitter 615 may transmit a frame comprising data for the multicast to the station, the frame comprising a header that conveys the assigned group ID. In some examples, the functional aspects of the receiver 605, multicast manager 610, and transmitter 615 may be integrated into a single wireless modem chip. Alternatively, these components may be implemented discretely.

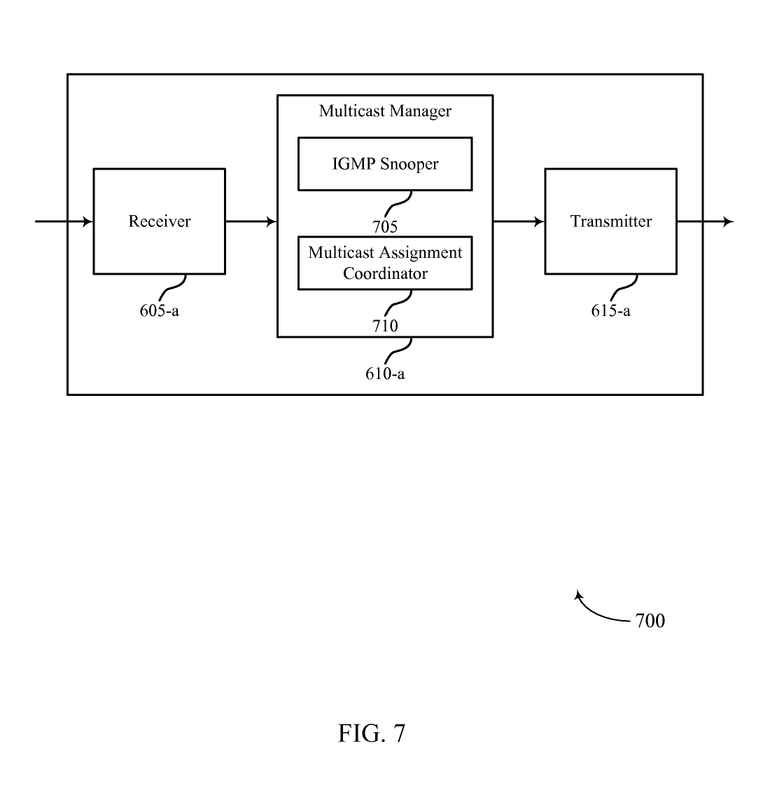

FIG. 7 shows a block diagram of a wireless device 700 for enhanced wireless multicast delivery in accordance with various aspects of the present disclosure. Wireless device 700 may be an example of aspects of a wireless device 600 or an AP 105 described with reference to FIGS. 1-6. Wireless device 700 may include a receiver 605-a, a multicast manager 610-a, or a transmitter 615-a. Wireless device 700 may also include a processor. Each of these components may be in communication with each other. The multicast manager 610-a may also include an IGMP snooper 705, and a multicast assignment coordinator 710.

The components of wireless device 700 may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 605-a may receive information which may be passed on to multicast manager 610-a, and to other components of wireless device 700. The multicast manager 610-a may perform the operations described above with reference to FIG. 6. The transmitter 615-a may transmit signals received from other components of wireless device 700.

The IGMP snooper 705 may determine, via internet group management protocol (IGMP) snooping, that a station is associated with a multicast as described above with reference to FIGS. 2-5. For example, the IGMP snooper may listen to IGMP messages exchanged between a network and a station and determine which multicast addresses the station is interested.

The multicast assignment coordinator 710 may assign a group ID to the station based at least in part on the determination as described above with reference to FIGS. 2-5. For instance, the multicast assignment coordinator may reference the association between a multicast and a station and assign a group ID to the STA 115 based on the association.

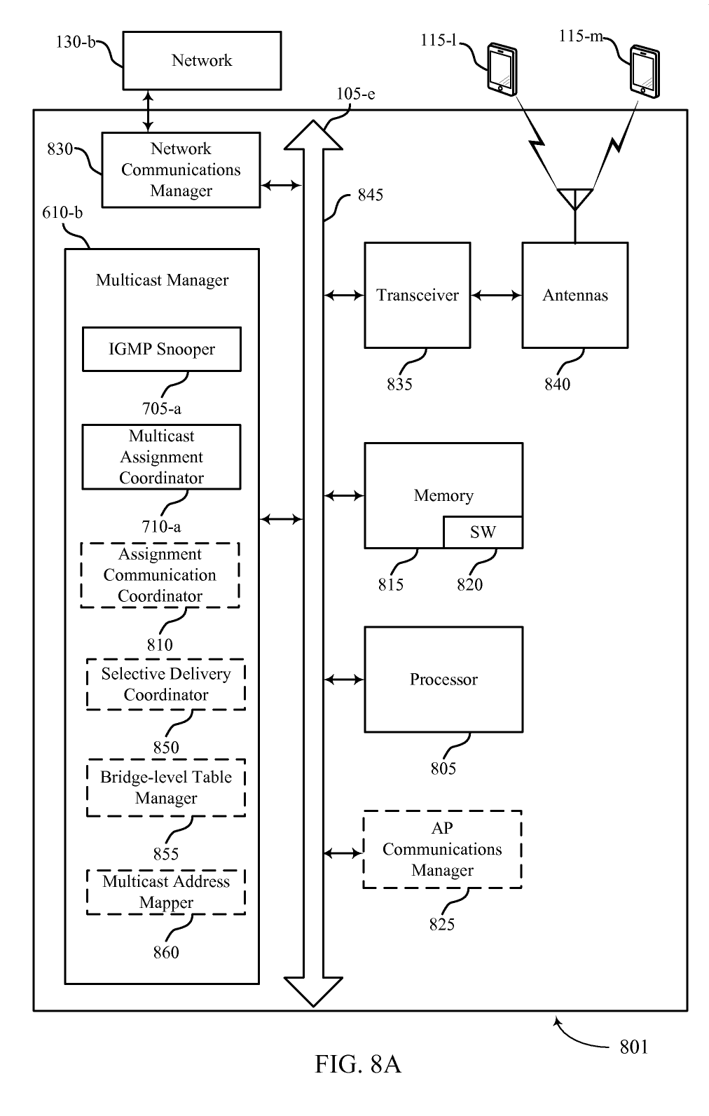

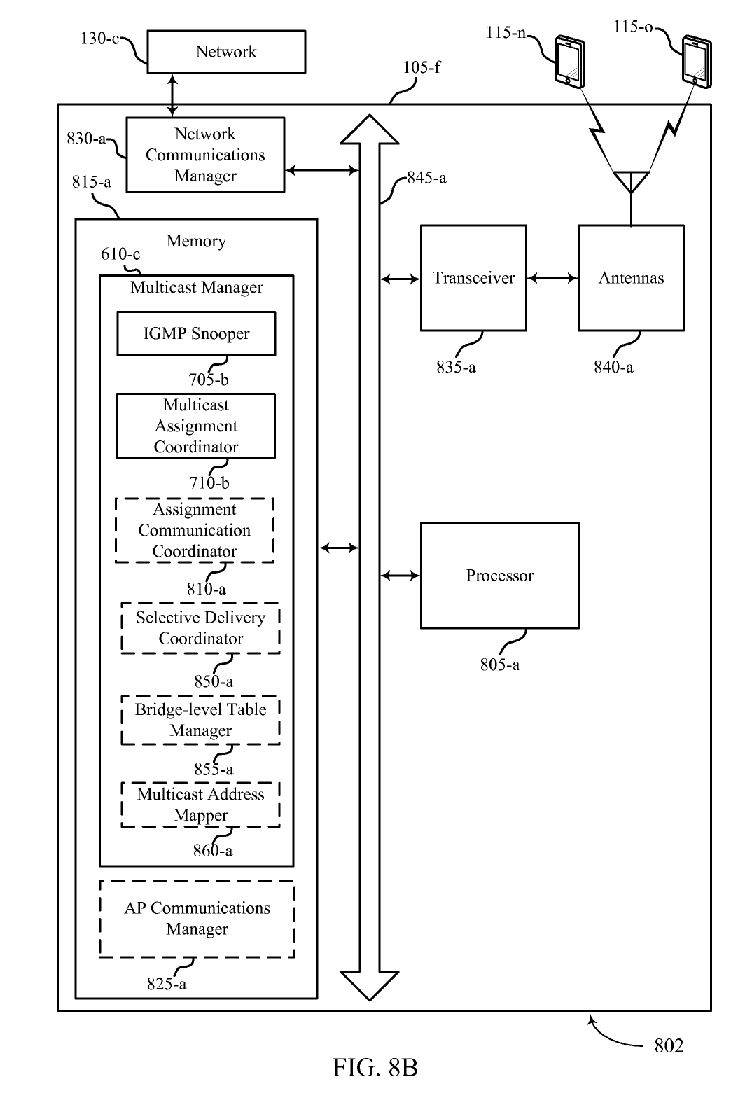

FIG. 8A shows a block diagram of a system 801 including AP 105-e configured for enhanced wireless multicast delivery, a plurality of STAs 115-1, 115-m, and a network 130-b in accordance with various aspects of the present disclosure. AP 105-e may be an example of an AP 105 described with reference to FIGS. 1-2, and 4-5, or an example of a device described with reference to FIGS. 6-7. AP 105-e may include a multicast manager 610-b, which may be an example of a multicast manger as described with reference to FIGS. 6-7. The multicast manager 610-b may include an IGMP snooper 705-a and a multicast assignment coordinator 710-a. Each of these components may perform the functions described above with reference to FIG. 7. The multicast manager 610-b may also include an assignment communication coordinator 810, a selective delivery coordinator 850, a multicast address mapper 860, and a bridge-level table manager 855.

AP 105-e may intercept messages exchanged between STA 115-1, STA 115-m and network 130-b. For example, AP 105-e may perform IGMP snooping by monitoring network communications manager 830 for IGMP subscriber messages. Using this information, the bridge-level table manager 855 may generate a bridge-level table which identifies the association between a STA 115 and a multicast, as described above with reference to FIGS. 2-5. The bridge-level table manager 855 may update the bridge-level table based at least in part on the IGMP snooping.

AP 105-e may reference the bridge-level table in order to map group IDs to STAs 115 according to the respective interests of the STAs 115. For example, the multicast address mapper 860 may assign a group ID based at least in part on the bridge-level table. According to the bridge-level table, STA 115-m may be interested in multicasts with a particular address. Using this information, the multicast address mapper 860 may select a group ID for STA 115-m. In other words, the multicast address mapper 860 may determine a group ID for a STA 115 based at least in part on a multicast address of a multicast as described above with reference to FIGS. 2-5.

The assignment communication coordinator 810 may be configured to communicate assigned group IDs to individual STAs 115. In some cases, assigning a group ID to a STA 115 may include transmitting the group ID to the STA 115 (e.g., via transceiver 835). For example, the assignment communication coordinator 810 may facilitate transmission of a unique group ID to STA 115-m. As discussed, the group ID may be based on IGMP snooping, and may associate a station with multicasts in which it is interested. The transmission of the group ID may be prior to transmitting a frame including the data for the multicast as described above with reference to FIGS. 2-5. Thus, a station (e.g., STA 115-m) may determine which multicasts are relevant by referencing the assigned group ID.

AP 105-e may steer multicast frames, or group IDs, in the direction of interested STAs 115 (e.g., STA 115-m) and away from uninterested STAs 115 (e.g., STA 115-1). For instance, the selective delivery coordinator 850 may be configured to manage transmission of the frame (e.g., by transceiver 835 or a transmitter 615). For example, based on information from the selective delivery coordinator 850, AP 105-e may use beamforming to steer transmission of the frame to STA 115-m as described above with reference to FIGS. 2-5. In the present example, this may include using beamforming to send the frame in the direction of STA 115-m. The selective delivery coordinator 850 may also identify a station as one of a number of stations associated with the group ID. Accordingly, AP 105-e may use beamforming to steer transmission of the frame to the number of interested stations. Based on information from the selective delivery coordinator 850, AP 105-e may avoid delivering the frame to a set of stations unassociated with the group ID (e.g., the transceiver 835 may avoid sending the frame to STA 115-1). The selective delivery coordinator 850 may coordinate the direction of the beamforming based on the locations of interested stations or uninterested stations.

The components of the multicast manager 610-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In some cases, AP 105-e may have one or more wired backhaul links. AP 105-e may have a wired backhaul link (e.g., S1 interface, etc.) to the network 130-b. AP 105-e may also communicate with other base stations 105 via inter-base station backhaul links. Each of the APs 105 may communicate with STAs 115 using the same or different wireless communications technologies. In some cases, AP 105-e may communicate with other APs utilizing AP communications manager 825. In some examples, AP communications manager 825 may provide an X2 interface within an LTE/LTE-A wireless communication network technology to provide communication between some of the APs 105. In some cases, AP 105-e may communicate with the network 130-b through network communications manager 830.

AP 105-e may include a processor 805, memory 815 (including software (SW) 820), transceiver(s) 835, and antenna(s) 840, which each may be in communication, directly or indirectly, with one another (e.g., over a bus 845). The transceiver(s) 835 may be configured to communicate bi-directionally, via the antenna(s) 840, with the STAs 115, which may be multi-mode devices. The transceiver(s) 835 (or other components of AP 105-e) may also be configured to communicate bi-directionally, via the antenna(s) 840, with the STAs 115-1, 115-m or other APs (not shown). The transceiver(s) 835 may include a modem configured to modulate the packets and provide the modulated packets to the antennas 840 for transmission, and to demodulate packets received from the antennas 840. AP 105-e may include multiple transceivers 835, each with one or more associated antennas 840. The transceiver(s) may be an example of a combined receiver 605 and transmitter 615 of FIG. 6.

The memory 815 may include RAM and ROM. The memory 815 may also store computer-readable, computer-executable software code 820 containing instructions that are configured to, when executed, cause the processor 805 to perform various functions described herein (e.g., enhanced multicast delivery etc.). Alternatively, the computer-executable software code 820 may not be directly executable by the processor 805 but be configured to cause (e.g., when compiled and executed) a computer to perform functions described herein. The processor 805 may include an intelligent hardware device (e.g., a CPU, a microcontroller, an ASIC, etc.). The processor 805 may include various special purpose processors such as encoders, queue processing modules, base band processors, radio head controllers, DSPs, and the like.

The AP communications manager 825 may manage communications with other APs 105. The AP communications manager 825 may include a controller or scheduler for controlling communications with STAs 115 in cooperation with other APs 105. For example, the AP communications manager 825 may coordinate scheduling for transmissions to STAs 115 for various interference mitigation techniques such as beamforming or joint transmission.

FIG. 8B shows a block diagram of a system 801 including AP 105-f configured for enhanced wireless multicast delivery in accordance with various aspects of the present disclosure. AP 105-f may be an example of an AP 105 described with reference to FIGS. 1-2, and 4-5, or an example of a device described with reference to FIGS. 6-7.

AP 105-f may include a processor 805-a, memory 815-a, transceiver 835-a, and antenna(s) 840-a, each of which may perform the functions described above with reference to FIG. 8A. In the present example, the memory 815-a may include software that performs the functionality of multicast manager 610-c. For example, memory 815-a may include software that, when compiled and executed, performs the functionality of an IGMP snooper 705-b, multicast assignment coordinator 710-b, assignment communication coordinator 810-a, selective delivery coordinator 850-a, bridge-level table manager 855-a, and multicast address mapper 860-a, such as described with reference to FIGS. 6-8A. In some cases, a subset of the functionality of multicast manager 610-c is included in memory 815-a; in other cases, all of the functionality may be implemented as software executed by the processor 805-a to cause the AP 105-f to perform the functions of multicast manager 610-c. For example, the functionality of the bridge-level table manager 855- and multicast address mapper 860-a may be accomplished by software included memory 815-a, while the functionality of IGMP snooper 705-b, multicast assignment coordinator 710-b, assignment communication coordinator 810-a, and selective delivery coordinator 850-a may be accomplished using hardware.

Other combinations of hardware/software to perform the functions of multicast manager 610-c may be used. In the present example, the functions of an AP communications manager 825-a may also be embodied as software stored in memory 815-a and executable by the processor 805-a. The AP communications manager 825-a may manage communications with other APs 105. The AP communications manager 825-a may include a controller or scheduler for controlling communications with STAs 115 in cooperation with other APs 105. For example, the AP communications manager 825-a may coordinate scheduling for transmissions to STAs 115 (e.g., STA 115-n and STA 115-o) for various interference mitigation techniques such as beamforming or joint transmission.

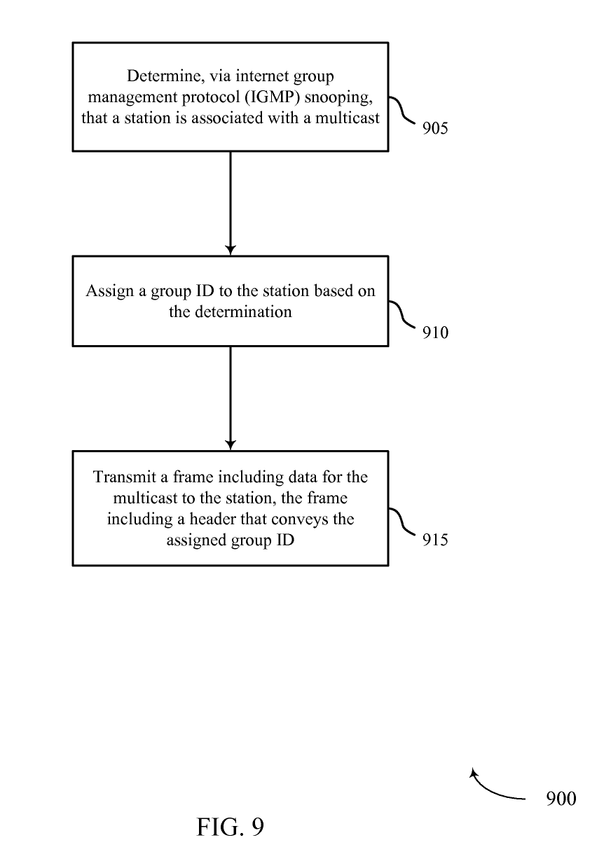

FIG. 9 shows a flowchart illustrating a method 900 for enhanced wireless multicast delivery in accordance with various aspects of the present disclosure. The operations of method 900 may be implemented by an AP 105 or its components as described with reference to FIGS. 1-8B. For example, the operations of method 900 may be performed by the multicast manager 610 as described with reference to FIGS. 6-8B. In some examples, an AP 105 may execute a set of codes to control the functional elements of the AP 105 to perform the functions described below. Additionally or alternatively, the AP 105 may perform aspects the functions described below using special-purpose hardware.

At block 905, the AP 105 may determine, via internet group management protocol (IGMP) snooping, that a station is associated with a multicast as described above with reference to FIGS. 2-5. In certain examples, the operations of block 905 may be performed by the IGMP snooper 705 as described above with reference to FIG. 7.

At block 910, the AP 105 may assign a group ID to the station based at least in part on the determination as described above with reference to FIGS. 2-5. In certain examples, the operations of block 910 may be performed by the multicast assignment coordinator 710 as described above with reference to FIG. 7.

At block 915, the AP 105 may transmit a frame comprising data for the multicast to the station, the frame comprising a header that conveys the assigned group ID as described above with reference to FIGS. 2-5. In some cases, transmitting the frame includes using beamforming to steer transmission of the frame to the station. In certain examples, the operations of block 915 may be performed by the transmitter 615 as described above with reference to FIG. 6.

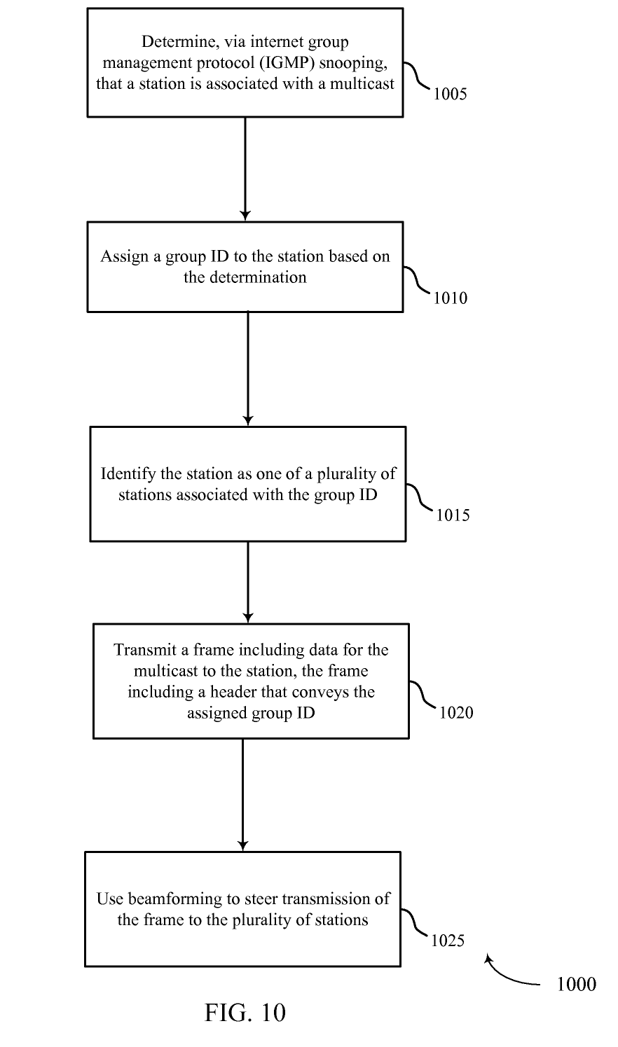

FIG. 10 shows a flowchart illustrating a method 1000 for enhanced wireless multicast delivery in accordance with various aspects of the present disclosure. The operations of method 1000 may be implemented by an AP 105 or its components as described with reference to FIGS. 1-8B. For example, the operations of method 1000 may be performed by the multicast manager 610 as described with reference to FIGS. 6-8B. In some examples, an AP 105 may execute a set of codes to control the functional elements of the AP 105 to perform the functions described below. Additionally or alternatively, the AP 105 may perform aspects the functions described below using special-purpose hardware. The method 1100 may also incorporate aspects of method 900 of FIG. 9.

At block 1005, the AP 105 may determine, via internet group management protocol (IGMP) snooping, that a station is associated with a multicast as described above with reference to FIGS. 2-5. In certain examples, the operations of block 1005 may be performed by the IGMP snooper 705 as described above with reference to FIG. 7.

At block 1010, the AP 105 may assign a group ID to the station based at least in part on the determination as described above with reference to FIGS. 2-5. In certain examples, the operations of block 1010 may be performed by the multicast assignment coordinator 710 as described above with reference to FIG. 7.

At block 1015, the AP 105 may identify the station as one of a plurality of stations associated with the group as described above with reference to FIGS. 2-5. In certain examples, the operations of block 1015 may be performed by the selective delivery coordinator 850 as described above with reference to FIG. 8A.

At block 1020, the AP 105 may transmit a frame comprising data for the multicast to the station, the frame comprising a header that conveys the assigned group ID as described above with reference to FIGS. 2-5. In certain examples, the operations of block 1020 may be performed by the transmitter 615 as described above with reference to FIG. 6.

At block 1025, the AP 105 may use beamforming to steer transmission of the frame to the plurality of stations as described above with reference to FIGS. 2-5. In certain examples, the operations of block 1025 may be performed by the transmitter 615 as described above with reference to FIG. 6.

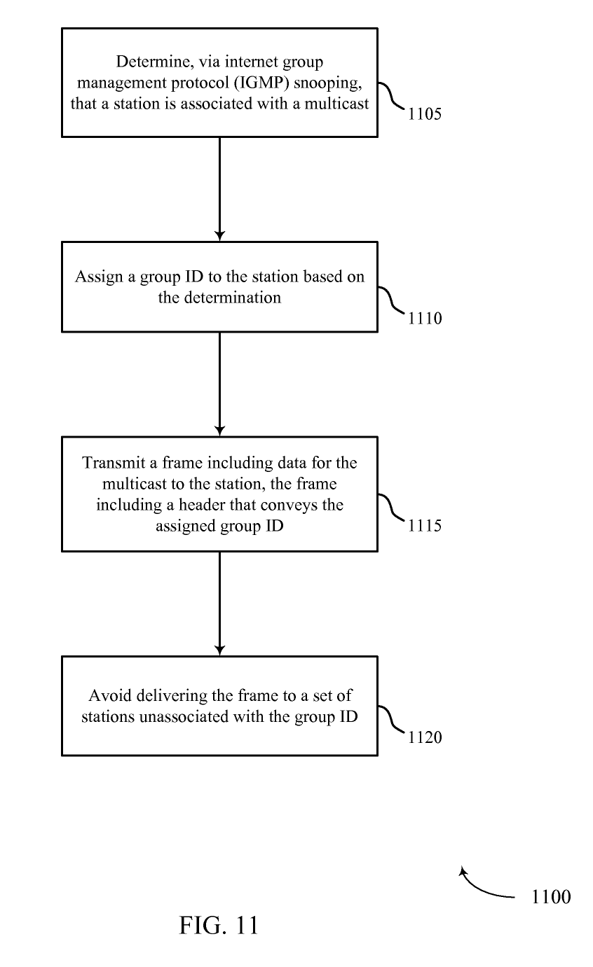

FIG. 11 shows a flowchart illustrating a method 1100 for enhanced wireless multicast delivery in accordance with various aspects of the present disclosure. The operations of method 1100 may be implemented by an AP 105 or its components as described with reference to FIGS. 1-8B. For example, the operations of method 1100 may be performed by the multicast manager 610 as described with reference to FIGS. 6-8B. In some examples, an AP 105 may execute a set of codes to control the functional elements of the AP 105 to perform the functions described below. Additionally or alternatively, the AP 105 may perform aspects the functions described below using special-purpose hardware. The method 1100 may also incorporate aspects of methods 900 and 1000 of FIGS. 9 and 10.

At block 1105, the AP 105 may determine, via internet group management protocol (IGMP) snooping, that a station is associated with a multicast as described above with reference to FIGS. 2-5. In certain examples, the operations of block 1105 may be performed by the IGMP snooper 705 as described above with reference to FIG. 7.

At block 1110, the AP 105 may assign a group ID to the station based at least in part on the determination as described above with reference to FIGS. 2-5. In certain examples, the operations of block 1110 may be performed by the multicast assignment coordinator 710 as described above with reference to FIG. 7.

At block 1115, the AP 105 may transmit a frame comprising data for the multicast to the station, the frame comprising a header that conveys the assigned group ID as described above with reference to FIGS. 2-5. In certain examples, the operations of block 1115 may be performed by the transmitter 615 as described above with reference to FIG. 6.

At block 1120, the AP 105 may avoid delivering the frame to a set of stations unassociated with the group ID as described above with reference to FIGS. 2-5. In certain examples, the operations of block 1120 may be performed by the selective delivery coordinator 850 as described above with reference to FIG. 8A.

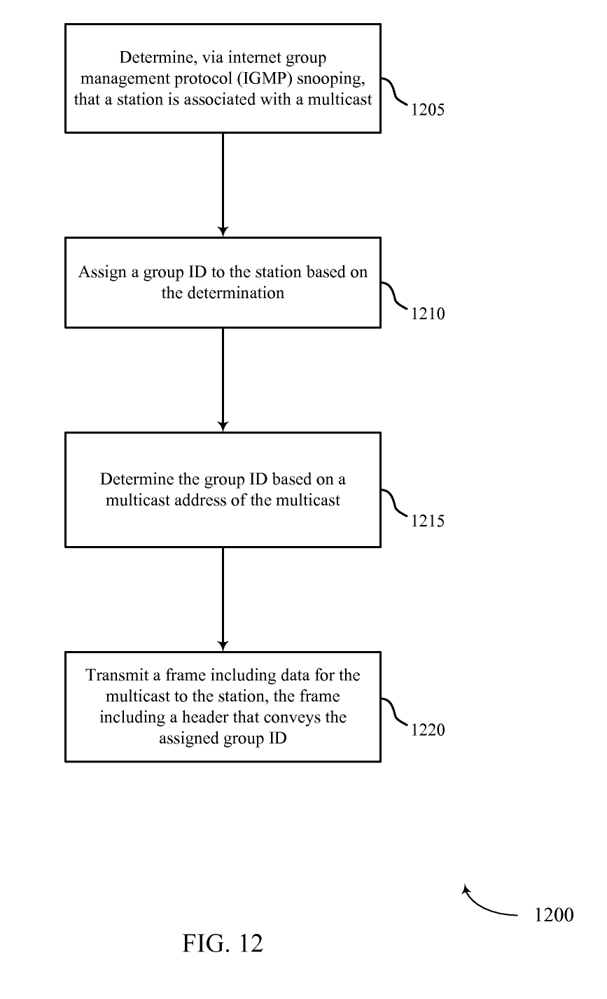

FIG. 12 shows a flowchart illustrating a method 1200 for enhanced wireless multicast delivery in accordance with various aspects of the present disclosure. The operations of method 1200 may be implemented by an AP 105 or its components as described with reference to FIGS. 1-8B. For example, the operations of method 1200 may be performed by the multicast manager 610 as described with reference to FIGS. 6-8B. In some examples, an AP 105 may execute a set of codes to control the functional elements of the AP 105 to perform the functions described below. Additionally or alternatively, the AP 105 may perform aspects the functions described below using special-purpose hardware. The method 1200 may also incorporate aspects of methods 900, 1000, and 1100 of FIGS. 9-11.

At block 1205, the AP 105 may determine, via internet group management protocol (IGMP) snooping, that a station is associated with a multicast as described above with reference to FIGS. 2-5. In certain examples, the operations of block 1205 may be performed by the IGMP snooper 705 as described above with reference to FIG. 7.

At block 1210, the AP 105 may assign a group ID to the station based at least in part on the determination as described above with reference to FIGS. 2-5. In certain examples, the operations of block 1210 may be performed by the multicast assignment coordinator 710 as described above with reference to FIG. 7.

At block 1215, the AP 105 may determine the group ID based at least in part on a multicast address of the multicast as described above with reference to FIGS. 2-5. In certain examples, the operations of block 1215 may be performed by the multicast address mapper 860 as described above with reference to FIG. 8A.

At block 1220, the AP 105 may transmit a frame comprising data for the multicast to the station, the frame comprising a header that conveys the assigned group ID as described above with reference to FIGS. 2-5. In certain examples, the operations of block 1220 may be performed by the transmitter 615 as described above with reference to FIG. 6.

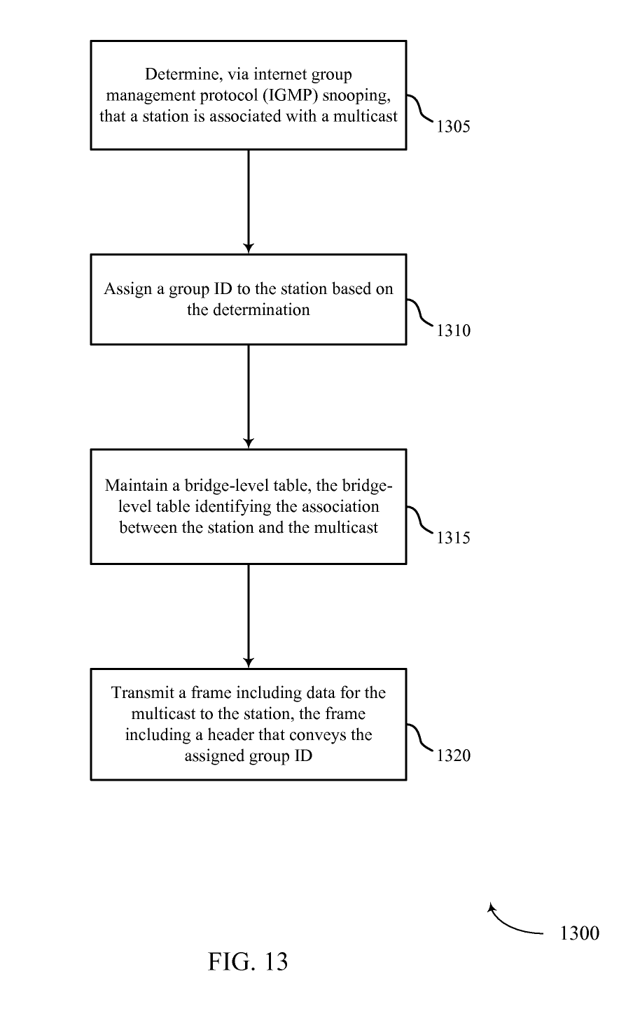

FIG. 13 shows a flowchart illustrating a method 1300 for enhanced wireless multicast delivery in accordance with various aspects of the present disclosure. The operations of method 1300 may be implemented by an AP 105 or its components as described with reference to FIGS. 1-8B. For example, the operations of method 1300 may be performed by the multicast manager 610 as described with reference to FIGS. 6-8B. In some examples, an AP 105 may execute a set of codes to control the functional elements of the AP 105 to perform the functions described below. Additionally or alternatively, the AP 105 may perform aspects the functions described below using special-purpose hardware. The method 1300 may also incorporate aspects of methods 900, 1000, 1100, and 1200 of FIGS. 9-12.

At block 1305, the AP 105 may determine, via internet group management protocol (IGMP) snooping, that a station is associated with a multicast as described above with reference to FIGS. 2-5. In certain examples, the operations of block 1305 may be performed by the IGMP snooper 705 as described above with reference to FIG. 7.

At block 1310, the AP 105 may assign a group ID to the station based at least in part on the determination as described above with reference to FIGS. 2-5. In certain examples, the operations of block 1310 may be performed by the multicast assignment coordinator 710 as described above with reference to FIG. 7.

At block 1315, the AP 105 may maintain a bridge-level table, the bridge-level table identifying the association between the station and the multicast as described above with reference to FIGS. 2-5. In certain examples, the operations of block 1315 may be performed by the bridge-level table manager 855 as described above with reference to FIG. 8A.

At block 1320, the AP 105 may transmit a frame comprising data for the multicast to the station, the frame comprising a header that conveys the assigned group ID as described above with reference to FIGS. 2-5. In certain examples, the operations of block 1320 may be performed by the transmitter 615 as described above with reference to FIG. 6.

Thus, methods 900, 1000, 1100, 1200, and 1300 may provide for enhanced wireless multicast delivery. It should be noted that methods 900, 1000, 1100, 1200, and 1300 describe possible implementation, and that the operations and the steps may be rearranged or otherwise modified such that other implementations are possible. In some examples, aspects from two or more of the methods 900, 1000, 1100, 1200, and 1300 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise random access memory (RAM), read only memory (ROM), electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of communication at a wireless device, comprising:
determining, via internet group management protocol (IGMP) snooping, that a station is associated with a multicast;
assigning a group identification (ID) to the station based at least in part on the determination; and
transmitting a frame comprising data for the multicast to the station, the frame comprising a header that conveys the assigned group ID.

2. The method of claim 1, wherein assigning the group ID to the station further comprises:
transmitting the group ID to the station prior to transmitting the frame comprising the data for the multicast.

3. The method of claim 1, wherein transmitting the frame further comprises:
using beamforming to steer transmission of the frame to the station.

4. The method of claim 3, further comprising:
identifying the station as one of a plurality of stations associated with the group ID; and
using beamforming to steer transmission of the frame to the plurality of stations.

5. The method of claim 1, further comprising:
avoiding delivering the frame to a set of stations unassociated with the group ID.

6. The method of claim 1, further comprising:
determining the group ID based at least in part on a multicast address of the multicast.

7. The method of claim 1, further comprising:
maintaining a bridge-level table, the bridge-level table identifying the association between the station and the multicast.

8. The method of claim 7, further comprising:
determining the group ID based at least in part on the bridge-level table.

9. The method of claim 7, further comprising:
updating the bridge-level table based at least in part on the IGMP snooping.

10. An apparatus for communication at a wireless device, comprising:
an internet group management protocol (IGMP) snooper to determine, via IGMP snooping, that a station is associated with a multicast;
a multicast assignment coordinator to assign a group identification (ID) to the station based at least in part on the determination; and
a transmitter to transmit a frame comprising data for the multicast to the station, the frame comprising a header that conveys the assigned group ID.

11. The apparatus of claim 10, wherein the transmitter is further to transmit the group ID to the station prior to transmitting the frame comprising the data for the multicast.

12. The apparatus of claim 10, wherein the transmitter is further to use beamforming to steer transmission of the frame to the station.

13. The apparatus of claim 12, further comprising:
a selective delivery coordinator to identify the station as one of a plurality of stations associated with the group ID; and wherein the transmitter uses beamforming to steer transmission of the frame to the plurality of stations.

14. The apparatus of claim 10, further comprising:
a selective delivery coordinator to avoid delivering the frame to a set of stations unassociated with the group ID.

15. The apparatus of claim 10, further comprising:
a multicast address mapper to determine the group ID based at least in part on a multicast address of the multicast.

16. The apparatus of claim 10, further comprising:
a bridge-level table manager to maintain a bridge-level table identifying the association between the station and the multicast.

17. The apparatus of claim 16, further comprising:
a multicast address mapper to determine the group ID based at least in part on the bridge-level table.

18. The apparatus of claim 16, wherein the bridge-level table manager is further to update the bridge-level table based at least in part on the IGMP snooping.

19. An apparatus for communication at a wireless device, comprising:
means for determining, via internet group management protocol (IGMP) snooping, that a station is associated with a multicast;
means for assigning a group identification (ID) to the station based at least in part on the determination; and
means for transmitting a frame comprising data for the multicast to the station, the frame comprising a header that conveys the assigned group ID.

20. The apparatus of claim 19, wherein the means for assigning the group ID to the station further comprises:
means for transmitting the group ID to the station prior to transmitting the frame comprising the data for the multicast.

21. The apparatus of claim 19, wherein the means for transmitting the frame further comprises:
means for using beamforming to steer transmission of the frame to the station.

22. The apparatus of claim 21, further comprising:
means for identifying the station as one of a plurality of stations associated with the group ID; and
means for using beamforming to steer transmission of the frame to the plurality of stations.

23. The apparatus of claim 19, further comprising:
means for avoiding delivering the frame to a set of stations unassociated with the group ID.

24. The apparatus of claim 19, further comprising:
means for determining the group ID based at least in part on a multicast address of the multicast.

25. The apparatus of claim 19, further comprising:
means for maintaining a bridge-level table, the bridge-level table identifying the association between the station and the multicast.

26. The apparatus of claim 25, further comprising:
means for determining the group ID based at least in part on the bridge-level table.

27. The apparatus of claim 25, further comprising:
means for updating the bridge-level table based at least in part on the IGMP snooping.

28. A non-transitory computer-readable medium storing code for communication at a wireless device, the code comprising instructions executable by a processor to cause the wireless device to:
determine, via internet group management protocol (IGMP) snooping, that a station is associated with a multicast;
assign a group identification (ID) to the station based at least in part on the determination; and
transmit a frame comprising data for the multicast to the station, the frame comprising a header that conveys the assigned group ID.

29. The non-transitory computer-readable medium of claim 28, wherein the instructions to assign the group ID to the station further comprise:
instructions executable by the processor to cause the wireless device to transmit the group ID to the station prior to transmitting the frame comprising the data for the multicast.

30. The non-transitory computer-readable medium of claim 28, wherein instructions to transmit the frame further comprise:
instructions executable by the processor to cause the wireless device to use beamforming to steer transmission of the frame to the station.
